(19) United States
(12) Patent Application Publication
(10) Pub. No.: US 2004/0069897 A1
(43) Pub. Date: Apr. 15, 2004

(54) Zero emitting electric air vehicle with semi-annular wing

(76) Inventor: William L. Corcoran, Henderson, NV (US)

Correspondence Address: ROBERTS ABOKHAIR & MARDULA, SUITE 1000, 11800 SUNRISE VALLEY DRIVE, RESTON, VA, 20191, US

(21) Appl. No.: 10/353,163

(22) Filed: Jan. 28, 2003

Related U.S. Application Data
(60) Provisional application No. 60/352,358, filed on Jan. 28, 2002.

(51) Int. Cl. B64C 27/22; B64C 39/00

(52) U.S. Cl. 244/10

(57) ABSTRACT

A zero emissions (non-polluting) electric powered air vehicle having dual lifting surfaces comprised of a blended wing-body and a semi-annular upper wing, the blended body comprising a fuselage volumetrically sized to house a fuel supply and propulsion subsystems, electric motors driving propellers to provide forward thrust for propelling the aircraft, a nacelle for carrying passengers, a source of fuel for supplying an electrochemical process that generates electric power, a ballistic parachute for safe descent of the passenger cabin in an emergency, and landing gear has been described. The electrochemical process emission is water in one embodiment of the present invention. Another embodiment describes is an unmanned version of the present invention. A further embodiment describes an auxiliary power source from externally mounted PV cells that convert solar energy to electricity wherein the auxiliary power is used to recover fuel from the water emissions by an electrolytic process.

### CROSS REFERENCE TO RELATED APPLICATIONS

This application claims priority from pending U.S. Provisional Patent Application Serial No. 60/352,358, filed Jan. 28, 2002.

### FIELD OF INVENTION

The present invention relates to non-polluting aircraft, specifically, an air vehicle powered by a hydrogen propulsion system with an electric motor and having a semi-annular upper wing.

### BACKGROUND

A recent study by the Institute for Public Policy Research (IPPR), London, has concluded: “aviation is the fastest growing source of transport greenhouse gases, although it is still small in proportion to others.” The earth's capacity to absorb carbon dioxide from the atmosphere is limited, and there is no known mechanism within the biosphere to rapidly absorb the large amounts of carbon dioxide emissions. However, utilizing hydrogen since it reacts with atmospheric oxygen to produce only water can eliminate these emissions.

NASA has had a long-standing interest in a “Zero-Emission Aircraft” (actually, the interest is in a zero polluting emissions aircraft). For example, status of the zero-emission aircraft was reviewed at the NASA Environmental Compatibility Research Workshop III, July 1998. At the NASA workshop, the following types of powered aircraft were considered: hydrogen-fuel (liquid/cryogenic only); methane-fuel (liquid/cryogenic only); nuclear aircraft; and fuel cell powered electric aircraft. NASA has rejected an aircraft powered solely by battery and photovoltaic cells.

Hydrogen conversion to electricity is an ideal power supply with respect to low polluting emissions. However, there is a need of large volume capacity to carry the fuel. Even in a liquid state, hydrogen requires three times displacement volume as the fossil fuel of choice, kerosene. However, hydrogen has three times energy availability relative to kerosene.

Since hydrogen is volatile, the use of wings as a storage tank is impractical, particularly since it is stored in tanks whether in liquid form or in gaseous form under pressure. Hydrogen, stored in an insulated tank, supplies fuel cells for electricity production.

A fuel cell is an apparatus for generating electricity by a chemical reaction. A fuel cell has two electrodes, cathode (positive) and anode (negative). The reactions that produce electricity take place at the electrodes.

Further, the fuel cell also has an electrolyte for carrying electrically charged particles between electrodes. There is also a catalyst that speeds the electrochemical reactions.

Besides hydrogen, the fuel cells require oxygen. Often, the oxygen source is from the air, but may be stored in a tank. Consistent with the non-polluting objective is that fuel cells generate electricity with near zero pollution. Hydrogen and oxygen ions combine to form water, a non-polluting byproduct.

Note that a fuel cell generates a small amount of direct current (DC) electricity. The fuel cells must be connected, usually assembled into a stack, to produce enough electric power to be practical.

In some types of fuel cells, oxygen enters the fuel cell at the cathode, combining with electrons returning from the electrical circuit along hydrogen ions. The hydrogen ions pass through the electrolyte from the anode to the cathode. In other cell types, oxygen picks up electrons, traverses through the electrolyte to the anode, and combines with hydrogen ions.

The electrolyte filters the ions that are allowed to pass between the electrodes. If free electrons (or other matter) were allowed to permeate the electrolyte, the chemical reaction would be disrupted.

Hydrogen and oxygen ions combine to form water, which is released (exhausted) from the cell. The fuel cell will generate electricity for as long as it is supplied with oxygen and hydrogen.

Fuel cells creating electricity chemically are not subject to thermodynamic laws limiting a conventional electric power generator. Fuel cells are therefore more efficient in extracting energy. Further, any heat that is a byproduct of the electrochemical reaction can be harnessed resulting in increased energy recovery.

The present invention uses a hydrogen fuel cell electric generation system. As noted above, the wings would not be appropriate storage tanks for the hydrogen. Therefore, the overall structural design of a hydrogen fueled electric aircraft, including the airfoil design, is not fixed. Further, the classical wing design that serves a dual purpose of lift agent and storage tank is not sacrosanct.

A design not often considered for air vehicles with commercial application is an annular wing design. However, annular (including semi-annular) wing design has been used in vertical take off and landing (VTOL) and vertical/short take off and landing (V/STOL) aircraft. Further, annual wing design has been used in biplanes and, more recently, in an “aerobatic” specialty plane called “Hummingbird”. FIGS. 1 and 2 are sketches of the Hummingbird specialty plane.

The Bell X-22 V/STOL, commissioned by the US Navy for use on aircraft carriers is illustrated in FIGS. 3 and 4. FIG. 3 is picture of a test prototype delivered by Bell Helicopter to the Navy in 1967. A design sketch of three aspects of the X-22 is illustrated in FIG. 4. Note that the X-22 uses four annular wings as well as horizontal canard wings close to the tail of the plane. Propeller engines were positioned on the upper, forward surface of the canard wings alongside the fuselage. The X-22 was also designed to study the use of annular wings in a tactical transport aircraft. The X-22 was abandoned by the Navy due to lack of speed.

Federal publication NACA TN 4117 dated October 1957—provides results of an experimental investigation in a wind tunnel for five annular airfoils. Some of the conclusions reached by the author, Herman S. Fletcher, are: lift-curve slopes for annular airfoils are approximately twice the lift-curve slopes for rectangular air foils having the same aspect ratio; induced drag coefficient for annular airfoils was half the induced drag coefficient of an elliptical airfoil; annular airfoils had larger lift/drag ratios (below aspect ratios of 2.4) than did plane unswept airfoils with faired tips. The net is that annular wings provide substantial lift capacity compared to classically shaped airfoils with the same aspect ratio. This information is available through NASA web site: http://naca.larc.nasa.gov/reports/1957/naca-tn-4117

It is expected that payload efficiency of fuel cells will increase by an order of magnitude in the next twenty years. The NASA projections for improved fuel cell performance indicate a 5× power/density increase by 2010 and a 10× improvement by 2020. Coupled with encouraging research from the automobile industry, use of fuel cell stacks to produce electric power for practical, commercial transport applications is promising. In year 2000, an advanced fuel cell was capable of producing 1 kW per 1 kg of weight. It is projected that this ratio will grow to 2 kW/1 kg in 2003, 5 kW/1 kg in 2010 and 10 kW/1 kg in 2020.

A fuel cell system comprises some if not all the following: a fuel processor, an oxygen supply subsystem, a subsystem for cooling, a reuse heat capture subsystem, and controls. Combining subsystems with a fuel cell creates a fuel cell engine for powering an air vehicle. The downside of using fuel cells is the amount of space required to store the fuel, to house the propulsion subsystems, and to house the fuel cells.

O'Connell et al., U.S. Pat. No. 6,223,843 entitled “Electrochemical propulsion system” addresses the issue of designing the storage and packaging of the fuel and the propulsion systems so as to provide sufficient room for a payload or passengers. The O'Connell patent applies to a terrestrial vehicle, but the teachings are applicable to an air vehicle as well. The concepts taught by O'Connell should help in reducing volume requirements in next generation fuel cell packaging and layout.

The most efficient fuel cell type is solid oxide. Solid oxide fuel cell (SOFC) is made totally from solid-state material, utilizing an oxide ceramic as the ion transporting electrolyte. SOFC operates in the 600-900° C. range. An SOFC is potentially 80% or more efficient in capturing the potential energy of the fuel. Further, it is ideal when the application is able to use the combined power and heat.

Another promising fuel cell type is the proton exchange membrane (PEM). A PEM fuel cell is made of two plates sandwiched together with a membrane. A supply of hydrogen and oxygen are fed through channels in the plates with hydrogen on one side of the membrane and oxygen on the other. The hydrogen and oxygen are drawn toward each other. The shortest path is through the membrane. Part of the hydrogen atom, the positive hydrogen ion, is able to pass through the membrane. The electron traverses an external circuit to get to the other side, thus providing a flow of electrons for power utilization. PEM fuel cell operates at a relatively low temperature (about 85° C.). A requirement that the hydrogen and oxygen supply be pure is more rigorous in a PEM system than SOFC system.

U.S. Pat. No. 6,218,035 to Fuglevand et al., entitled “Proton exchange membrane fuel cell power system” teaches the application of force to PEM diffusion membranes to improve energy recovery and efficiency of PEM fuel cell systems. Other processes, including the use of more than two membranes are also presented. The Fuglevand patent teachings point to greater efficiencies and practicality of PEM fuel cell usage in vehicles.

One advantage of a PEM fuel cell system in a military application is that the relatively low operational heat of PEM systems prohibits heat seeking missiles from honing in an aircraft using this propulsion system.

Further, in a commercial application, the absence of noise from an electric propulsion system provides an advantage with respect to lowered noise pollution and passenger comfort.

There are other known fuel cell systems. The PEM and SOFC systems are currently the most promising for a commercial transport application for terrestrial and air vehicles. Other fuel cell systems, known or yet undiscovered, should not be discounted.

What is desired is a zero pollution emitting air vehicle, based on electric motor driven propellers, deriving power from hydrogen fuel cell stacks, and the structure is designed from the start with the propulsion system and fuel configuration in mind. Since the wings will not serve as a storage tank, particular attention can be made to the wing design to reflect the propulsion system characteristics.

What is furthered desired is an unmanned, zero pollution emitting aircraft based on electric motor driven propellers, deriving power from hydrogen fuel cell stacks, and a means of replenishing fuel without having to land, thus increasing loitering time. The aircraft is designed from the start with the propulsion system, fuel configuration, recovery system and unmanned operation.

### SUMMARY OF THE INVENTION

It is the objective of the present invention to use hydrogen as a fuel for to be converted to electricity to propel an air vehicle, wherein the emissions are virtually pollution free.

It is another objective of the present invention to design the air vehicle to accommodate substantial payload and achieve significant range given the fuel and propulsion system.

It is a further objective of the present invention to use a semi-annular wing in the air vehicle structural design.

It is still another objective of the present invention to use a canard wing in addition to the semi-annular wing in the air vehicle structural design.

It is yet another objective of the present invention to use a nacelle for carrying passengers wherein the nacelle is integrally designed in the air vehicle structure.

It is still a further objective of the present invention to use a ballistic parachute positioned above and to the rear (aft) of the nacelle for additional safety wherein the nacelle will disengage from the fuselage under emergency conditions and be lowered by parachute.

It is another objective of the present invention to have the aircraft configured for an unmanned version, thus reducing the size and weight of the craft.

It is still a further objective of the present invention to provide a fuel recovery system thereby extended the flight time of the aircraft.

It is yet another objective of the present invention to incorporate a second power supply to power a fuel recovery system.

It is yet a further objective of the present invention to incorporate a secondary power supply to augment the primary power supply.

The present invention is a propeller driven air vehicle powered by electric motors. Fuel cells in a stack configuration provide electric power through an electrochemical process. The fuels used are hydrogen and oxygen, although other fuels may be used without going outside of the scope of the present invention. The objective of this invention is to virtually eliminate polluting emissions and still have a commercially viable air vehicle.

Because storing hydrogen fuel requires substantial volume and special containerization, the wings of this aircraft will not serve as a storage tank. The present invention stores the hydrogen fuel tanks in the fuselage. Propulsion subsystems are also located in the fuselage. The fuselage will reflect volumetric sizing requirements that accommodate hydrogen storage tanks and an integrated fuel cell power system. The fuselage tapers to a flat trailing edge.

The present invention uses a fresh design to incorporate the needed features of the air vehicle, integrating the craft's structure around the propulsion system as opposed to retrofitting other aircraft design to accommodate the propulsion system. The fuselage is designed for functional integration of the various components. It is also blended into the lower lifting surface with some lateral stability achieved from slight dihedral of the blended body.

In an embodiment of the present invention, a space-frame structural platform with an aeroshell constructed from composite material is included for structural integrity.

In one embodiment of the present invention, there is a semi-annular wing, a canard wing, a nacelle that can breakaway from the fuselage in an emergency, a fuselage reflecting volumetric sizing to house the fuel tanks, fuels cells (which are configured as stacks) as the means to electrochemically convert fuel (e.g., hydrogen and oxygen) to electricity, efficient electric motors to drive propellers, and a ballistic parachute to safely lower the nacelle under emergency conditions. Further, the electric motors are variable so as to provide adequate thrust at takeoff and to run efficiently when reaching flight altitude.

The byproduct of the electrochemical process will be electricity and virtually non-polluting emissions (e.g., water) thus eliminating nitrogen oxides and carbon oxides from the emissions. The lightness of the fuel, the lightness of the electric motors, the high efficiency of the energy recovery from the fuel, the elimination of need to reinforce the fuselage where storage tank wings joined causing the fuselage to be a “torque box” thus reducing the fuselage's weight, superior lift characteristics of a semi-annular upper wing combine to provide commercially viable air vehicle.

An alternative embodiment of the present invention provides for an unmanned aircraft version wherein the nacelle is eliminated or substantially reduced, thus lightening the overall weight of the aircraft. It is desirable for an unmanned craft to remain aloft for extended periods. In one embodiment of the unmanned version, a secondary power supply is used to recover hydrogen and oxygen fuel by an electrolytic process applied to the water emission of the fuel cell energy conversion process.

In this embodiment of the present invention, photovoltaic (PV) collectors are attached to the surface of the aircraft. The solar energy is converted to electric energy by PV cells. This supplemental electric energy is used to break down water into its oxygen and hydrogen components by an electrolytic process. The oxygen and hydrogen gasses are compressed and stored in tanks that were spent in the fuel cell energy conversion process. This way the fuel tanks are replenished and can be reused until the electric motors require overhaul or until solar energy is insufficient due to clouds or nighttime flight. The primary energy source is from electrochemical conversion of hydrogen and oxygen to electricity.

Two electrochemical means to convert fuel to electricity include proton exchange membrane fuel cell (PEM) and solid oxide fuel cell (SOFC) are suggested in the present invention. However, any other efficient, commercially viable means of converting fuel to electric power that results in non-polluting emissions is within the scope of the present invention and should not be ruled out.

### SUMMARY OF FIGURES

FIG. 1 is a sketch of a Hummingbird “Aerobatic” aircraft as discussed above as an example of the use of annular wings.

FIG. 2 is a more detailed sketch of the Hummingbird aircraft. FIG. 2 was discussed above.

FIG. 3 is a picture of the Bell X-22 V/STOL prototype 1967 vintage. The Bell X-22 was discussed above as another example of an aircraft using annular airfoils.

FIG. 4 is a three aspect sketch of the Bell X-22 V/STOL as discussed above.

FIG. 5 illustrates a conceptual configuration for a manned version of the H2 AV (hydrogen Air Vehicle).

FIG. 6 illustrates a cross section of a semi-annular wing design for one configuration of the H2 AV.

FIG. 7 illustrates a schematic of an electrochemical propulsion system used to power the present invention.

FIG. 8 illustrates Architectural drawing of multiple views of an embodiment of the present invention (H2 AV).

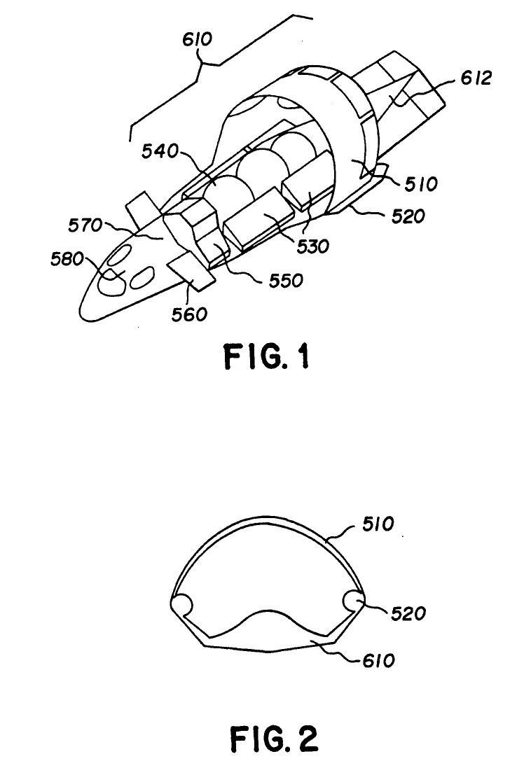

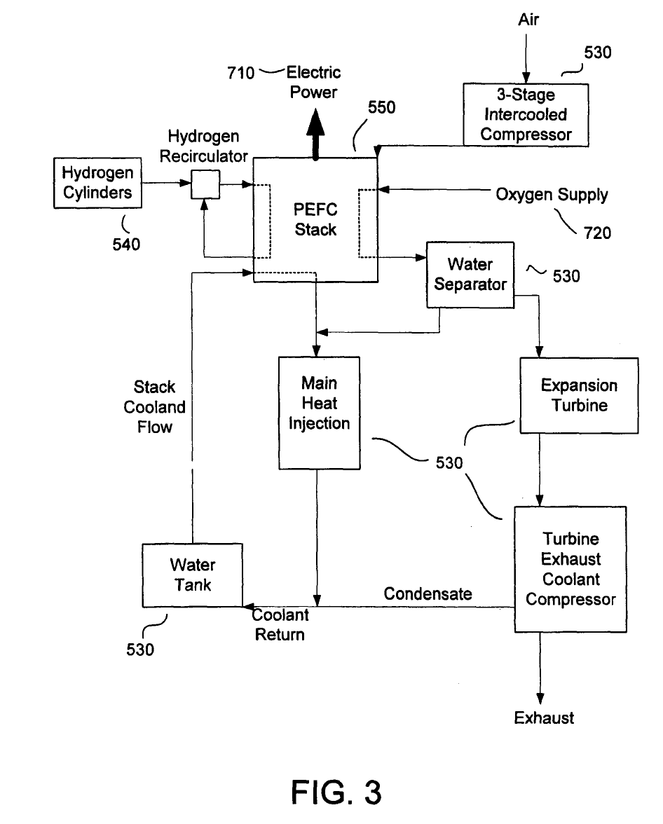

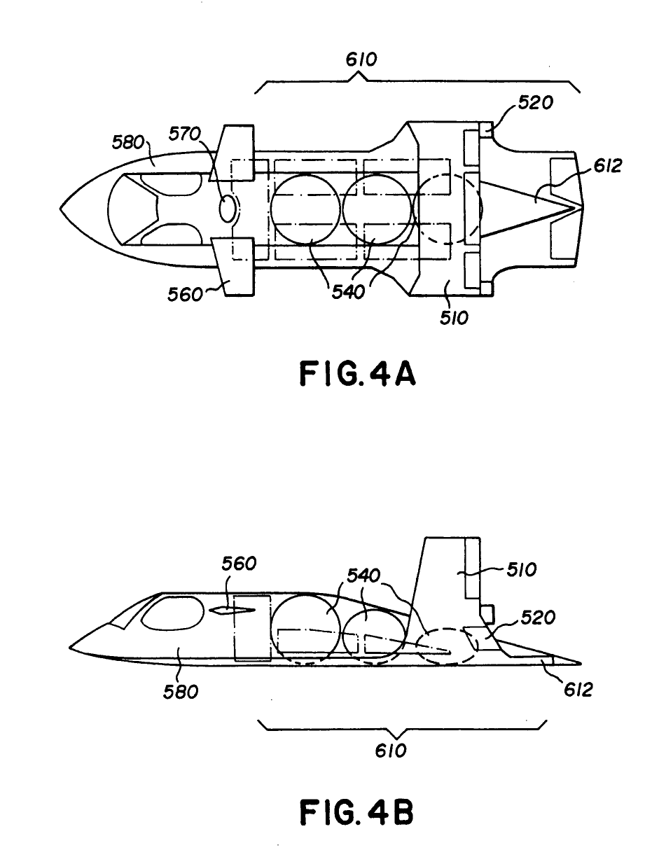

### DETAILED DESCRIPTION OF THE INVENTION

The present invention is an air vehicle that has virtually no polluting emissions. One embodiment of the present invention uses an electrochemical process based on fuel cell technology to generate an electric current. The aircraft, dubbed H2 AV, is fueled, in one embodiment, by hydrogen stored in tanks in a liquid state or gaseous state under pressure. The hydrogen is processed along with oxygen to generate electric power. Alternative, non-limiting embodiments, include a proton exchange membrane (PEM) fuel cell electrochemical process and a solid oxide fuel cell (SOFC) electrochemical process. Other electrochemical processes that convert fuel into electric power and any emissions from the process that are non-polluting are within the scope of the present invention.

The fuselage is volumetrically sized to be able to store fuel (e.g., hydrogen), the fuel cells in stacks and propulsion subsystems. The fuselage tapers to flat trailing edge flaps. Retractable landing gear are located under the weight concentrations of propellant and motors for structural efficiency. A steerable nose wheel located forward of the cabin.

A semi-annular airfoil is attached mid fuselage. One embodiment of the present invention is designed with a pair of low weight, high efficiency electric motors each positioned behind the semi-annular airfoil above the fuselage. The electric motors have variable speed gearing and operational efficiencies for high thrust requirements at takeoff and economical operation when the craft is at cruising altitude.

The propellers in one embodiment are “pusher” type (i.e., mounted behind the semi annular wing allowing for superior aerodynamics. The pusher propeller concept allows undisturbed airflow over the main blended body and semi-annular wing to enhance laminar flow and reduce drag.

One embodiment of the present invention is designed to carry one or more passengers. The pPassengers are carried in a nacelle pod that is integrated (blended) into the aircraft structure. In one embodiment of the present invention the nacelle is designed to disengage from the fuselage in the event of an emergency. There is a ballistic parachute placed in a compartment at the top and rear of the nacelle pod to safely lower the pod if it should be disengaged from the fuselage.

In one embodiment of the present invention, the aircraft is designed to be unmanned. In this embodiment, the nacelle is eliminated or reduced. However, an instrumentation area is maintained. Since passengers will not be present, aircraft dimensions are reduced, as is the payload requirement. The aircraft's wing surface, fuselage, fuel capacity and energy systems are similarly scaled down.

In the alternative, the aircraft dimensions are maintained at or near the dimensions of the manned version, thus allowing extended operational time. Extended flight time is an important consideration if the present invention is to be employed as a surveillance aircraft.

In one embodiment, the aircraft is powered by a hydrogen-air fuel cell system that uses gaseous hydrogen as fuel. The system includes a fuel cell that combines a reactant of gaseous hydrogen with oxygen and outputs electric power and water. The fuel cell powers an inverter that runs a motor that drives a compressor to compress outside air to provide oxygen for the fuel cell. The air and hydrogen combine in the fuel cell to create the power both for the compressor's inverter, and for an inverter to run a propellor motor.

In accordance with one embodiment of the present invention, an aircraft is configured to operate with gaseous hydrogen at approximately 15 psi. However, unlike typical hydrogen-powered systems, which are designed with complex thermal and mechanical systems to operate at air pressures greater than one atmosphere, the present embodiment is preferably designed to operate at internal pressures of down to 2 or 3 psia, significantly reducing the cost and weight of the system while increasing its reliability during high-altitude flight.

A fuel cell uses liquid hydrogen that is stored in the fuel tank as a hydrogen source. Storing the fuel as a liquid provides for the fuel to be stored in a volume that is small enough to fit reasonable aircraft shapes. Preferably, the cryogenic container(s) necessary to carry the fuel are relatively lightweight and fit in the body of the aircraft.

Other known hydrogen sources such as gaseous hydrogen tanks are within the scope of the invention. As described above, the fuel cell uses ambient air as an oxygen source. Other known oxygen sources such as oxygen tanks are also within the scope of the invention.

In accordance with one embodiment, the fuel tank includes an inner aluminum tank liner, having an inner carbon layer formed on it, and an outer aluminum tank liner, with an outer carbon layer formed on it. The internal radius of the inner aluminum layer is preferably four feet. Such a tank is capable of holding approximately 1,180 pounds of liquid hydrogen.

In accordance with one embodiment, a fuel cell is configured to operate at one or more power-generation rates that require the gaseous hydrogen to be supplied at related operating-rates of flux. Heat received by the liquid hydrogen via convection through insulated tank walls causes the liquid hydrogen to boil at a boiling-rate lower than one or more (and preferably all) of the anticipated boiling-rates desired to produce gaseous hydrogen at the related operating-rates of flux. However, if a hybrid power system (e.g., a combination fuel cell and solar cell system) is used, there might be times when a zero boiling rate would be preferred.

To provide hydrogen to the fuel cell at an acceptable rate over the convection boiling rate, heat is either delivered to, or generated in, the fuel tank by a heat source. That heat source is configured to increase the boiling-rate of the liquid hydrogen to one or more desired boiling-rates adequate to supply gaseous hydrogen to the fuel cell at an operating-rate of flux. A fuel tank is configured to supply hydrogen to the fuel cell at a rate related to and/or determined by the boiling-rate of the hydrogen, and thus operate the fuel cell at a power-generation rate adequate to power generation needs.

Based on the recited fuel and propulsion system, it is estimated that the aircraft, with a gross weight of 4,000 pounds, can loiter at 60,000 feet MSL within an area of 3,600 feet, with a speed of 130 feet per second, and a potential dash speed of 180 feet per second when necessary. To maintain a presence within the loiter diameter, the aircraft will bank up to 15 degrees in turning maneuvers.

A common role for embodiments of the aircraft will be to substitute for solar-powered aircraft, such as the one disclosed in U.S. Pat. No. 5,810,284 (the '284 patent), that cannot stationkeep for part or all of the year in some locations due to strong winds and/or limited solar radiation, such as is associated with long nights and low angles of available sunlight during the winter at high latitudes.

In one embodiment of the present invention, an aircraft is fueled by liquid hydrogen reacted with atmospheric oxygen in a fuel cell and include solar cells to prolong its flight in conditions having extensive available solar radiation. Furthermore, other hybrid combinations of power sources are used, including ones using regenerative fuel cells.

In a further embodiment of the present invention, an auxiliary or secondary power supply is introduced. One embodiment uses photovoltaic (PV) collectors, positioned on the exterior of the aircraft, to harvest solar energy. Solar energy is converted to electrical energy by PV cells. In a preferred embodiment, the electrical energy from PV cells is used to convert collected water emissions from the fuel cell electrochemical process into hydrogen and oxygen components.

Water is broken down to its elemental components through an electrolytic process powered by electricity supplied by PV cells. The hydrogen and oxygen gasses are compressed and stored in fuel tanks spent in producing electricity in the primary electric generation system.

In other embodiments of the present invention, electrical energy from solar energy harvesting can be stored in batteries. In an alternative embodiment, PV sourced electric power can be integrated with the primary electric supply, thus lessening the load on the primary system. In a further embodiment, PV sourced electric supply can be combined in various hybrid systems that use some combination of the electrolytic process, storage batteries and integrated supply.

In a preferred embodiment of the present invention, Aa small, horizontal canard wing, positioned on either side of the fuselage, aft and near the top of the passenger nacelle, is present. The canard wing helps in stall resistance and provides some vehicle stability and control in pitch and roll. The blended body forms a slight dihedral that enhances the lateral stability of the aircraft. In the unmanned version of the present invention, where the nacelle is not present, the canard wing is positioned forward a main fuselage. The nose of the aircraft is tapered for improved aerodynamics and stability.

Blended body refers to the fuselage blended into the lower lifting surface and lower sections of the wing extending up to the motor nacelles. The present invention air vehicle actually has dual lifting surfaces. In one embodiment, not illustrated, a rear vertical stabilizer is present for further control and improved handling characteristics.

One embodiment of the present invention has a space-frame platform main structure covered with lightweight composite material designed for easy access to functional systems such as spherical fuel containers, landing gear, fuel cell stacks, avionics, etc. Vehicle safety is enhanced through stringent hydrogen propellant storage requirements and, as described earlier, a ballistic parachute located aft of the passenger cabin.

Referring to FIG. 5, one conceptual configuration therefore a manned version of the H2 AV is illustrated. A semi-annular airfoil 510 attaches to the fuselage 610 near the rear of the fuselage 610 that tapers to a flat trailing edge 612. Within the fuselage 610, fuel cell stack 550, fuel storage tanks 540, and propulsion subsystems 530 are located. The electrochemical process occurs within the fuselage 610 and the electric power generated by the fuel cell stack 550 is used by the electric motors 520 located at the rear of the semi-annular airfoil 510 in one embodiment of the present invention.

The electric motors 520 may be positioned elsewhere on the airfoil or the fuselage. However, as illustrated, the electric motors, as positioned, lend themselves to superior aerodynamics. Not illustrated are propellers mounted on and driven by the electric motors. The electric motors 520 are variable speed, lightweight motors. The embodiment illustrated use “pusher” type propellers. Other types of propellers, such as “puller” type, may be used without going outside the scope of the present invention.

Integrated and blended into the forward fuselage is the passenger pod or nacelle 580. Mounted aft of the nacelle is a canard wing 560 positioned on either side. The canard wing 560 provides some stability and control as well as helps with stall resistance. The dihedral formed with the body improves lateral stability. Positioned on the top aft of the nacelle 580 is a ballistic parachute 570. The nacelle, in one embodiment, disengages from the fuselage 610 under emergency conditions and the ballistic parachute 570 is deployed to lower the nacelle 580 with passengers safely to the Earth's surface.

It is also noted that the design of the present invention focuses on vehicle safety. Fuselage configuration reflects stringent hydrogen propellant safety storage requirements. Volumetric requirements, dictated by the hydrogen storage system, fuel cells, oxygen storage system, propulsion conditioning systems, etc. are part of the overall fuselage configuration design. In one embodiment of the present invention, the fuselage tapers to a flat trailing edge.

In the unmanned version of the present invention (not illustrated), the nacelle is reduced or eliminated. However, the aircraft's basic configuration follows the overall design of the manned version. The canard wing is positioned near the front of the aircraft. In one embodiment, the unmanned aircraft's instruments are clustered forward the fuselage in a pod. This pod is separable from the fuselage in the event of an emergency. A ballistic parachute, stored at the top and rear of the instrument pod, is deployed for a safe descent so that any data gathered during flight can be recovered.

Referring to FIG. 6, a cross section at the mid-chord line of the semi-annular wing is illustrated. The semi-annular airfoil 510 is positioned above the fuselage 610 and is attached to the fuselage's upper aspect. A pair of electric motors 520 are also depicted.

Referring to FIG. 7, a schematic of an electrochemical propulsion system used to power the present invention is illustrated. Propulsion subsystems 530 are shown as schematically surrounding a fuel cell stack 550. FIG. 7 illustrates one embodiment of the present invention where the fuel cell stack 550 is comprised of a plurality of proton exchange fuel cells (PEFC) and is labeled as a PEFC Stack 550. Note that PEFC is sometimes referred to as a PEM (proton exchange membrane) fuel cell.

The PEFC stack 550 is fueled by hydrogen that has been stored in hydrogen cylinders or storage tanks 540 and oxygen 720. The oxygen supply 720 is drawn from the atmosphere in an embodiment of the present invention. Resultant electric power 710 is used by the aircraft's electrical system and provides the energy to drive the electric motors.

An alternate embodiment, the oxygen supply 720 is drawn from oxygen storage tanks. It is noted that fuels such as oxygen and hydrogen may be present in “pure” form or may be extracted from the atmosphere or chemical compounds. The scope of the present invention includes alternative embodiments supplying various fuels from various sources. What is relevant to the present invention is the availability of a fuel or fuels that, when undergoing electrochemical processing, generate electric power.

As discussed supra, in one embodiment of the present invention, an auxiliary power source, PV cells, is used to replenish hydrogen and oxygen fuel tanks that have been spent in the electrochemical fuel cell process. Water that has been emitted by the fuel cell process is collected and stored. PV collectors harvest solar energy. PV cells convert solar energy to electrical energy. The electricity thus generated is used to break the stored water into its elements, hydrogen and oxygen. The hydrogen and oxygen gasses are compressed and used to charge spent fuel tanks. In this way, the fuel supply is re-generated and the aircraft is able to remain aloft for extended periods. This ability to remain aloft for extended periods is particularly significant for unmanned craft that are serving a surveillance function.

Referring to FIG. 8, an architectural drawing of multiple views of an embodiment of the present invention is illustrated. The aircraft comprises a fuselage 610 which tapers at the trailing edge 612, a semi-annular airfoil 510, with electric motors 520 mounted at the rear of the semi-annular wing 510. Fuel storage tanks 540 are positioned inside the fuselage 610. A nacelle passenger compartment 580 is integrated and positioned at the front of the fuselage. A canard wing 560 mounted on either side of the nacelle 580 to help stall resistance and provide some stability and control of the air vehicle in pitch and roll. A ballistic parachute 570 is mounted within a compartment on the top aft of the nacelle 580.

A non-polluting, zero emission electric aircraft has now been illustrated. It is important to note that while particular electrochemical processes were described in embodiments (i.e. PEFC and SOFC) this is not meant as a limitation. For example molten carbonate and alkaline fuel cells are alternate sources for electric power production.

It will be apparent to those skilled in the art that other variations in, for example and without limitation, the type of propeller, source of fuel and engine locations can be accomplished without departing from the scope of the invention as disclosed. Further, use of varying hybrid power generation systems is within the scope of the present invention.

I claim:

1. An air vehicle with virtually no polluting emissions comprising: an engine; a propulsion system; a fuselage for storing a source of fuel; a nacelle for carrying passengers; a semi-annular wing for providing lift; and landing gear, wherein
the engine is an electric motor and wherein the propulsion system further comprising a propeller for propelling the air vehicle, the propeller being driven by the electric motor.

2. The air vehicle of claim [c1] wherein the fuel is hydrogen and oxygen and further comprising a means for converting the fuel to electric current for powering the electric motor.

3. The air vehicle of claim [c2] wherein the means for converting the fuel to electric current comprising a fuel cell.

4. The air vehicle of claim [c1] further comprising a canard wing for resisting stall and providing some pitch and roll stability and control.

5. The air vehicle of claim [c1] further comprising a ballistic parachute positioned to the aft and on the upper surface of the nacelle for lowering the passengers safely when said ballistic parachute is deployed.

6. The air vehicle of claim [c5] further comprising a disengagement device for disengaging the nacelle from the fuselage upon an event wherein the ballistic parachute is deployed when the nacelle has become disengaged from the fuselage.

7. The air vehicle of claim [c3] further comprising a supplemental power system for generating electrical power.

8. The air vehicle of claim [c7] wherein the supplemental power system comprising:
photovoltaic collectors positioned on the aircraft's outer surface for harvesting solar energy; and photovoltaic cells for converting solar energy into electrical energy.

9. The air vehicle of claim [c8] further comprising: an emissions collector for collecting and storing water emission from the fuel cell; an electrolytic processor for generating hydrogen and oxygen from the water emission; an oxygen charger for charging spent fuel tanks with generated oxygen; a hydrogen charger for charging spent fuel tanks with generated hydrogen wherein the electrolytic processor, the oxygen charger and the hydrogen charger are powered by the supplementary power system.

10. The air vehicle of claim [c8] wherein the supplemental power system powers one or more devices from the group of devices comprising: an electrolytic processor for generating hydrogen and oxygen from water; a charger for charging electric storage batteries; and an electronic supply integrator for integrating electric power supplies.

11. An air vehicle comprising:
a propulsion system including at least one electrical engine and at least one fuel cell;
a fuselage holding the at least one engine and at least one fuel cell;
a semi-annular wing;
landing gear;
an emissions collector for collecting and storing water emission from the at least one fuel cell;
an electrolytic processor for generating hydrogen and oxygen from the water emission;
an oxygen charger for charging spent fuel tanks with generated oxygen;
a hydrogen charger for charging spent fuel tanks with generated hydrogen;
wherein the electrolytic processor, the oxygen charger and the hydrogen charger are powered by a supplementary power system.

12. The air vehicle of [c11] wherein further comprising a supplemental power system comprising: photovoltaic collectors positioned on the aircraft's outer surface; and photovoltaic cells for converting solar energy into electrical energy.

13. The air vehicle of claim [c12] wherein the supplemental power system powers one or more devices from the group of devices comprising: an electrolytic processor for generating hydrogen and oxygen from water; a charger for charging electric storage batteries; and an electronic supply integrator for integrating electric power supplies.

14. The air vehicle of claim [c11] further comprising a canard wing.

15. The air vehicle of claim [c12] further comprising:
an emissions collector for collecting and storing water emission from the fuel cell;
an electrolytic processor for generating hydrogen and oxygen from the water emission;
an oxygen charger for charging spent fuel tanks with generated oxygen;
a hydrogen charger for charging spent fuel tanks with generated hydrogen;
wherein the electrolytic processor, the oxygen charger and the hydrogen charger are powered by the supplementary power system.
